(19) United States
(12) Patent Application Publication
(10) Pub. No.: US 2016/0220332 A1
(43) Pub. Date: Aug. 4, 2016

(54) METHOD FOR MANUFACTURING CUSTOMIZED ABUTMENT

(71) Applicant: MEDIT CORP., Seoul (KR)

(72) Inventors: Min Ho Chang, Seoul (KR); Myoung Woo Song, Seoul (KR)

(21) Appl. No.: 15/024,885

(22) PCT Filed: Sep. 22, 2014
(86) PCT No.: PCT/KR2014/008784

§ 371 Date: Mar. 25, 2016

(30) Foreign Application Priority Data
Oct. 8, 2013 (KR) 10-2013-0120016

(51) Int. Cl. A61C 8/00; A61C 9/00

(52) U.S. Cl. CPC A61C 8/0001; A61C 9/00

(57) ABSTRACT

A method for manufacturing a customized abutment is disclosed. The method for manufacturing a customized abutment, includes: coupling a second coping in a combination of a copied fixture (or a copied analog) same as the actual fixture and the second coping same as the first coping with the negative impression of the first coping formed in the impression body; performing scanning; removing the second coping from a scanned image; designing an abutment coupled to the actual fixture; and manufacturing an actual abutment suitable for a patient by using the designed abutment. Thus, since a manufacturing time of the abutment is shortened, productivity is improved and at the same time, it is possible to manufacture a customized abutment for a patient.

### FIELD OF THE INVENTION

The present invention relates to a method for manufacturing a customized abutment.

### BACKGROUND OF THE INVENTION

There are a variety of methods for dental treatments including orthodontic treatments, filling treatments, and prosthodontic treatments. A dental implant treatment is included in prosthodontic treatments.

The dental implant treatment is a therapy for placing a titanium fixture appropriate for a living body into a jawbone around an area where a tooth is missed or pulled out and restoring natural teeth functions by coupling prosthesis with the fixture.

For dental implants, one of the important matters is to implement a teeth model same as or similar to the shape of an affected area.

A conventional method for manufacturing an abutment to be coupled with a fixture and an artificial tooth is explained.

A titanium screw-shaped actual fixture is placed into an area of a jawbone where a tooth has been pulled out. After a certain period of time when the actual fixture completely integrates into the jawbone, one side of a first coping for impression is coupled with one side of the actual fixture that faces the outside of the jawbone. At the time, it is natural that the other side of the first coping is exposed to the outside of the jawbone.

Since then, after impression materials are applied around the first coping, gums and teeth that are not pulled out, an impression body of the first coping and teeth around the first coping is taken. A negative impression of the first coping and that of the teeth are formed in the impression body.

A combination of a copied fixture (or a copied analog) with a structure same as or similar to the actual fixture and the first coping separated from the actual fixture is coupled with the impression body where the negative impression of the first coping is formed. At the time, the first coping is coupled with the area of the impression body where the negative impression of the first coping is formed and the copied fixture (or the copied analog) is exposed to the outside of the impression body.

Since then, a plaster teeth model is formed by pouring plaster into the impression body. At the time, the copied fixture (or the copied analog) is inserted into the inside of the plaster teeth model and the first coping is exposed to the outside of the plaster teeth model.

After the first coping is removed and a coping for acquiring data is coupled with the copied fixture (or the copied analog), the plaster teeth model is scanned and coordinates of the copied fixture (or the copied analog) are obtained by using the coping for acquiring the data. By using the acquired coordinates of the copied fixture (or the copied analog) and data of the scanned plaster teeth model, the abutment to be coupled with the actual fixture placed into the jawbone is manufactured and prosthesis such as an artificial tooth coupled with the abutment is manufactured.

Because the conventional method for manufacturing an abutment as shown above uses plaster, it takes a long time to harden plaster. This decreases productivity.

It is difficult to obtain an accurate abutment due to the expansion of plaster.

The prior arts related to the present invention are disclosed in the Korean Patent Laid-Open Publication No. 10-2011-0020323, etc.

### SUMMARY OF THE INVENTION

It is an object of the present invention to solve all the aforementioned problems.

It is an object of the present invention to provide a method for manufacturing a customized abutment capable of improving productivity and allowing the customized abutment fit for a patient to be obtained at the same time.

In accordance with one aspect of the present invention, there is provided a method for manufacturing an abutment, including steps of: (a) placing an actual fixture into a jawbone from which one or more teeth are pulled out; (b) coupling a first coping for impression with one side of the actual fixture that faces the outside of the jawbone; (c) applying impression materials around the first coping and taking an impression body where negative impression of the first coping and that of teeth are formed; (d) coupling a second coping in a combination of a copied fixture (or a copied analog) with a structure same as or similar to the actual fixture and the second coping same as or similar to the first coping with the negative impression of the first coping formed in the impression body; (e) acquiring a negative teeth model by scanning the impression body with which the combination is coupled by using a scanning device; (f) acquiring a positive teeth model to make the copied fixture (or the copied analog) implanted and to make the second coping exposed by converting the negative teeth model; (g) removing the second coping; (h) replacing the copied fixture (or the copied analog) of the positive teeth model with data of the actual fixture, and designing an abutment at the area where the second coping has been removed; and (i) manufacturing an actual abutment by using the designed abutment.

### BRIEF DESCRIPTION OF THE DRAWINGS

The above and other objects and features of the present invention will become apparent from the following description of preferred embodiments given in conjunction with the accompanying drawings, in which:

FIGS. 1A through 1D are diagrams showing a method for manufacturing a customized abutment in accordance with one example embodiment of the present invention.

### DETAILED DESCRIPTION OF THE PREFERRED EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the present invention, although different, are not necessarily mutually exclusive. For example, a particular feature, structure, or characteristic described herein in connection with one embodiment may be implemented within other embodiments without departing from the spirit and scope of the present invention. In addition, it is to be understood that the position or arrangement of individual elements within each disclosed embodiment may be modified without departing from the spirit and scope of the present invention. The following detailed description is, therefore, not to be taken in a limiting sense, and the scope of the present invention is defined only by the appended claims, appropriately interpreted, along with the full range of equivalents to which the claims are entitled. The length, size, thickness and shape of example embodiments illustrated in drawings may be expressed exaggeratedly for convenience.

To allow those skilled in the art to the present invention to be carried out easily, the example embodiments of the present invention by referring to attached diagrams will be explained in detail as follows:

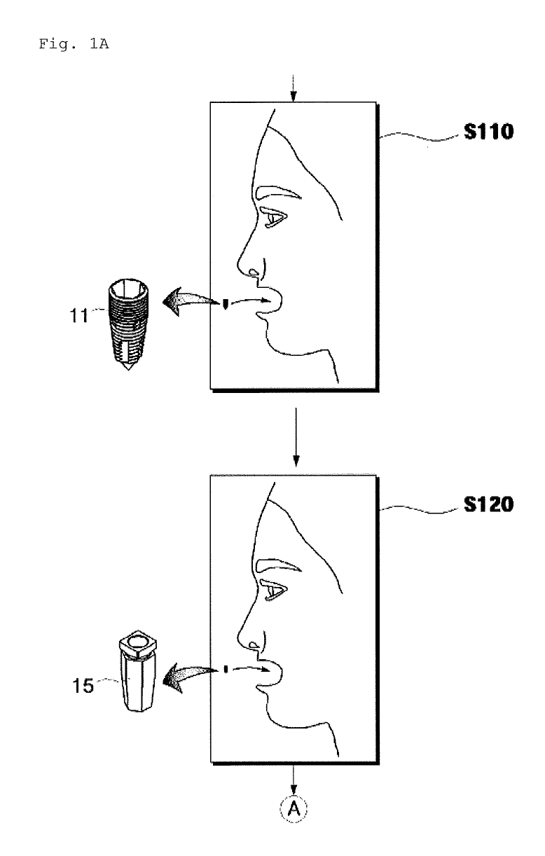

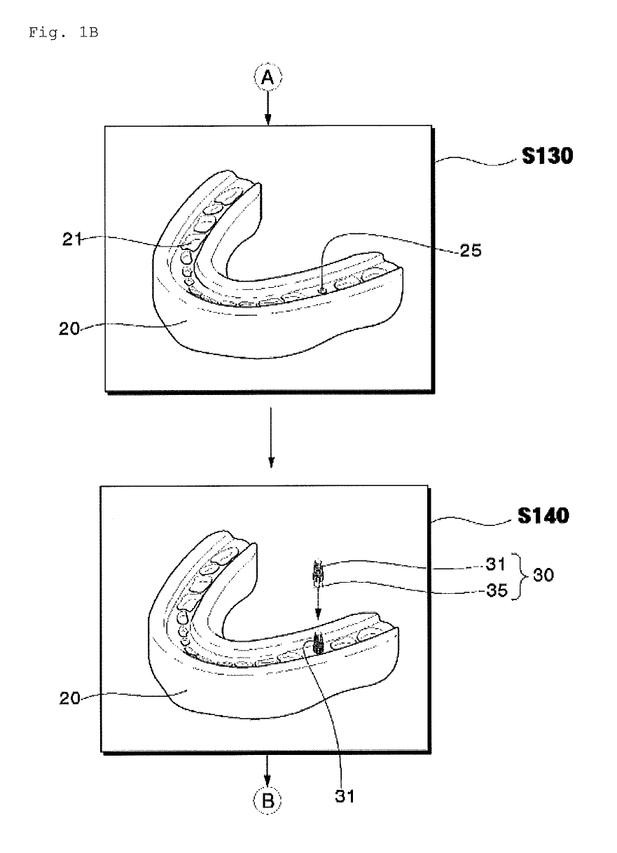

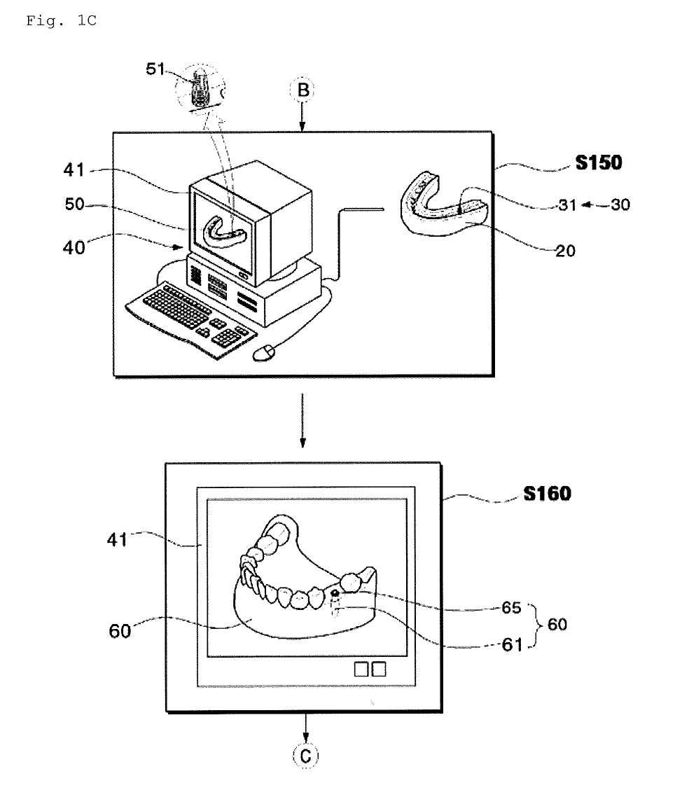

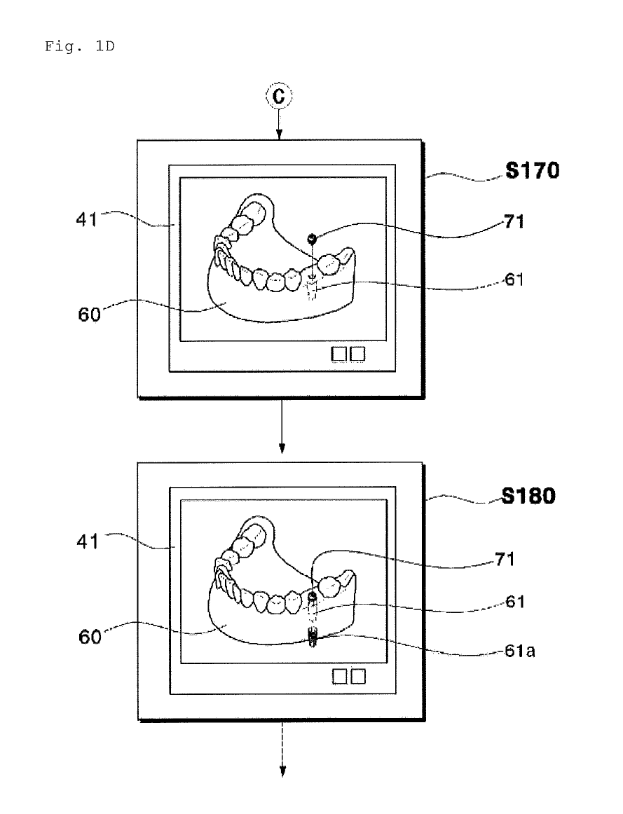

FIGS. 1A through 1D are diagrams showing a method for manufacturing a customized abutment in accordance with one example embodiment of the present invention.

As illustrated in the drawings, at a step of S110, a titanium screw-shaped actual fixture 11 is made and is placed into a jawbone where one or more teeth is pulled out by using a jig, etc.

At a step of S120, after the actual fixture 11 completely integrates into the jawbone, one side of a first coping 15 for an impression is coupled with one side of the actual fixture 11 that faces the outside of the jawbone. At the time, the other side of the first coping 15 is exposed to the outside of the jawbone.

To make directionality, an inner surface of the actual fixture 11 and an external surface of the first coping 15, which is inserted into and is coupled with the inner surface of the actual fixture 11, may be oval, triangular, quadrangular, pentagonal, hexagonal or polygonal in a mutually symmetrical shape. Since the inner surface of the actual fixture 11 is formed in an oval or polygonal shape and the external surface of the first coping 15 is formed in an oval or polygonal shape, the first coping 15 is prevented from being rotated when the first coping 15 is inserted into and coupled with the actual fixture 11.

At a step of S130, after impression materials are applied around the first coping 15, gums, and teeth that are not pulled out, an impression body 20 of the teeth around the first coping 15, including the first coping 15, is taken. Then, a negative impression 21 of the teeth and a negative impression 25 of the first coping are formed in the impression body 20.

At a step of S140, a combination 30 is coupled with the negative impression 25 of the first coping formed in the impression body 20. The combination 30 is a configuration of combining a copied fixture (or a copied analog) 31 and a second coping 35 with each other. The copied fixture (or the copied analog) 31 has the structure same as or similar to the actual fixture 11 and the second coping 35 is same as or similar to the first coping 15. At the time, the second coping 35 in the combination 30 is coupled with the negative impression 25 of the first coping formed in the impression body 20, and the copied fixture (or the copied analog) 31 is exposed to the outside of the impression body 20.

To have directionality, an inner surface of the copied fixture (or the copied analog) 31 and an external surface of the second coping 35, which is inserted into and is coupled with the inner surface of the copied fixture (or the copied analog) 31, may be formed in a mutually symmetrical oval, triangular, quadrangular, pentagonal, hexagonal or polygonal shape.

After that, a negative teeth model 50 is acquired by scanning the impression body 20 with which the combination 30 is coupled through a scanning device 40 including a monitor 41, at a step of S150 and a positive teeth model 60 is acquired by converting the negative teeth model 50 at a step of S160.

In the negative teeth model 50, a copied fixture (or a copied analog) 51 is exposed and a second coping (non-illustrated) is implanted, but in the converted positive teeth model 60, a copied fixture (or a copied analog) 61 is implanted and a second coping 65 is exposed. The negative teeth model 50 may be converted into the positive teeth model 60 by using scanner software, etc.

At a step of S170, the second coping 65 is removed while the monitor 41 of the scanning device 40 is looked at.

At a step of S180, while the monitor 41 of the scanning device 40 is looked at, a teeth model is manufactured by replacing the copied fixture (or the copied analog) 61 in the positive teeth model 60 with data 61A of the actual fixture 11. The copied fixture (or the copied analog) 61 in the positive teeth model 60 may be replaced with the data 61A of the actual fixture because the copied fixture (or the copied analog) 31 may be deformed during a manufacturing process of the teeth model. The copied fixture (or the copied analog) 61 in the positive teeth model 60 may be replaced with the data 61A of the actual fixture by overlapping the data 61A of the actual fixture with the copied fixture (or the copied analog) 61 in the positive teeth model 60. An abutment 71 where one side will be coupled with the data 61A of the actual fixture and the other side will be coupled with an artificial tooth is designed.

After that, it is properly processed by using Computer Aided Design (CAD) software and Computer Aided Manufacturing (CAM) software and coordinates of the data 61A of the actual fixture in the teeth model are acquired by using the data 61A of the actual fixture. By using the coordinates of the acquired data 61A of the actual fixture, the abutment 71 which will be coupled with the actual fixture 11 that has been placed into the jawbone is designed. By using the designed the abutment 71, an actual abutment 13 customized for a patient and prosthesis, including an artificial tooth, are manufactured.

In a method for manufacturing a teeth model in accordance with one example embodiment of the present invention, the second coping 35 in the combination 30 of the copied fixture (or the copied analog) 31 with the structure same as or similar to the actual fixture 11 and the second coping 35 same as or similar to the first coping 15 is coupled with the negative impression 25 of the first coping formed in the impression body 20 and scan it. After the second coping is removed from the scanned image through the monitor 41, the abutment to be coupled with the actual fixture is designed and then the actual abutment fit for a patient is manufactured by using the designed abutment. Therefore, the method may shorten the time of manufacturing the actual abutment and manufacture the abutment customized for a patient at the same time.

The drawings in the example embodiment of the present invention described as shown above are exemplarily illustrated to make it easy to identify the technical concept of the present invention by omitting detailed outline. Besides, the aforementioned example embodiment cannot be a reference limiting the technical concept of the present invention, but it is just a reference to understand the technical matters included in the claims of the prevent invention.

The method for manufacturing the customized abutment in accordance with the present invention is to couple a second coping in a combination of a copied fixture (or a copied analog) with a structure same as or similar to an actual fixture and the second coping same as or similar to a first coating with an impression area of the first negative coping formed in the impression body and then scan it, remove the second coating in the scanned image, design an abutment to be coupled with the actual fixture, and manufacture an actual abutment fit for a patient by using the designed abutment. The present invention has effects of improving productivity by shortening the time of manufacturing an abutment and manufacturing a customized abutment fit for a patient at the same time.

What is claimed is:

1. A method for manufacturing an abutment, comprising steps of:
(a) placing an actual fixture into a jawbone from which one or more teeth are pulled out;
(b) coupling a first coping for impression with one side of the actual fixture that faces the outside of the jawbone;
(c) applying impression materials around the first coping and taking an impression body where negative impression of the first coping and that of teeth are formed;
(d) coupling a second coping in a combination of a copied fixture (or a copied analog) with a structure same as or similar to the actual fixture and the second coping same as or similar to the first coping with the negative impression of the first coping formed in the impression body;
(e) acquiring a negative teeth model by scanning the impression body with which the combination is coupled by using a scanning device;
(f) acquiring a positive teeth model to make the copied fixture (or the copied analog) implanted and to make the second coping exposed by converting the negative teeth model;
(g) removing the second coping;
(h) replacing the copied fixture (or the copied analog) of the positive teeth model with data of the actual fixture, and designing an abutment at the area where the second coping has been removed; and
(i) manufacturing an actual abutment by using the designed abutment.

2. The method of claim 1, wherein an inner surface of the actual fixture and an external surface of the first coping that are coupled with each other and an inner surface of the actual fixture and an external surface of the second coping that are coupled with each other have their directionality, respectively.

3. The method of claim 2, wherein the inner surface of the actual fixture and the external surface of the first coping are oval or polygonal in a mutually symmetrical shape; and
the inner surface of the actual fixture and the external surface of the second coping are oval or polygonal in a mutually symmetrical shape.

4. The method of claim 1, wherein the copied fixture (or the copied analog) of the positive teeth model is replaced with the data of the actual fixture by overlapping the data of the actual fixture with the copied fixture (or the copied analog) of the positive teeth model.
